(19) United States
(12) Patent Application Publication
(10) Pub. No.: US 2026/0179872 A1
(43) Pub. Date: Jun. 25, 2026

(54) PULSED ELECTRON BEAM SOURCE WITH GAP DOMINANT INTEGRATED ENERGY STORAGE AND ULTRAFAST CAPABILITY

(71) Applicant: Leon Rivkin, Old Brookville, NY (US)

(72) Inventor: Leon Rivkin, Old Brookville, NY (US)

(21) Appl. No.: 19/426,679

(22) Filed: Dec. 19, 2025

Related U.S. Application Data
(60) Provisional application No. 63/735,936, filed on Dec. 19, 2024.

(51) Int. Cl. H01J 29/96; H01J 29/48

(52) U.S. Cl. CPC H01J 29/96; H01J 29/48

(57) ABSTRACT

An electron beam source includes a vacuum chamber containing a cathode and an anode separated by a vacuum gap forming a local full-voltage capacitive structure storing electrical energy at an operating voltage. A high-voltage power supply charges the capacitive structure without an intervening Marx generator, linear transformer driver, Tesla transformer, pulse-forming network, or pulse-forming transmission line. A triggering arrangement initiates electron emission to produce electron pulses traversing the vacuum gap, with discharged electrical energy transferred predominantly to electrons crossing the gap. In some embodiments, the local capacitive structure stores a majority of total electrical energy stored at the operating voltage in capacitances directly coupled between conductors at cathode and anode potentials. Multi-beam configurations, beam steering, passive synchronization, and contamination management features may be included.

### CROSS-REFERENCE TO RELATED APPLICATIONS

This application claims the benefit of priority under 35 U.S.C. § 119 (e) to U.S. Provisional Patent Application No. 63/735,936, filed on Dec. 19, 2024, entitled “Ultra Fast, High Current Electron Beam Source with Integrated Capacitive Energy Storage,” the entire disclosure of which is hereby incorporated by reference in its entirety for all purposes.

The present application may be related to other applications in a common portfolio directed to high-energy pulsed systems, diagnostics, controls, and energy-handling subsystems. The disclosures of such related applications, to the extent they exist and to the extent not inconsistent herewith, are hereby incorporated by reference for all purposes.

### STATEMENT REGARDING FEDERALLY SPONSORED RESEARCH OR DEVELOPMENT

The subject matter described herein was not made under, and is not subject to, any contract, grant, or award with any agency of the United States Government.

### BACKGROUND OF THE DISCLOSURE

### Field of the Disclosure

The present application relates generally to high-voltage electron beam systems. More particularly, the present application relates to electron beam sources configured to produce pulsed electron beams, including electron pulses in nanosecond and sub-nanosecond regimes in some embodiments, and further including embodiments configured for longer pulse durations while retaining the same energy storage architecture.

### Description of Related Art

High-current electron beam sources are used in a range of applications including flash X-ray radiography, pulsed imaging, high-energy-density physics, plasma diagnostics, inertial confinement fusion research, materials processing, security screening, industrial inspection, and related pulsed irradiation applications.

Many known pulsed electron beam systems employ external pulsed-power assemblies to generate and deliver a shaped high-voltage waveform to an electron gun or vacuum diode. Such external pulsed-power assemblies may include large capacitor banks, Marx generators, linear transformer drivers (LTDs), Tesla transformers, pulse-forming networks (PFNs), pulse-forming transmission lines, switching elements, and high-voltage interconnects. In such architectures, the electron gun is typically treated as a load at the end of a pulse-forming chain, and capacitance associated with the gun is commonly treated as parasitic rather than as a deliberate primary energy storage element.

External pulsed-power assemblies and their interconnections can increase system size, mass, cost, and complexity. They can also introduce parasitic inductance and stray capacitance that reduce the efficiency and repeatability with which stored energy is delivered into an electron beam on short time scales, particularly when peak currents are high and allowable timing jitter is small.

Certain vacuum devices, including multi-electrode guns and three-terminal devices (e.g., triodes and triggered vacuum switches), can employ control electrodes to influence conduction across a vacuum gap. However, in many such systems the primary energy storage and pulse formation remain associated with external components, and anode-cathode capacitance is treated as a secondary effect that influences commutation behavior or waveform shape rather than as the principal full-voltage energy reservoir used to directly accelerate electrons across the same gap.

High-current pulsed operation can also present practical engineering constraints. For example, electrode erosion and material ablation may occur at localized emission and impact regions, and ablated material can deposit on vacuum insulators and other surfaces, potentially reducing breakdown margins and limiting lifetime, particularly at higher pulse energies and/or higher repetition rates.

Accordingly, there remains a need for electron beam source architectures that reduce or eliminate reliance on large external pulse-forming assemblies for producing a pulsed electron beam, and that store at least a substantial fraction of pulse energy locally at the emission/acceleration gap so that a comparatively low-power high-voltage supply may function primarily as a charger operating on a time scale longer than the pulse duration. In some embodiments, it is further desirable that such architectures support multiple beams, optional trajectory control, and/or passive timing relationships to external events, while maintaining practical provisions for vacuum integrity and lifetime.

### SUMMARY OF THE DISCLOSURE

The present disclosure describes an electron beam source comprising a vacuum chamber, a cathode and an anode disposed within the vacuum chamber and separated by a vacuum gap, and a local full-voltage capacitive structure located within the vacuum chamber and electrically coupled between a conductor at cathode potential and a conductor at anode potential, including a vacuum gap capacitance between the cathode and the anode.

In some embodiments, a high-voltage power supply is coupled to the cathode and the anode and configured to charge the local full-voltage capacitive structure to a predetermined operating voltage.

In some embodiments, a triggering arrangement is configured to initiate emission of electrons from the cathode to form at least one electron pulse that traverses the vacuum gap toward the anode.

In some embodiments, electrical energy stored at the operating voltage in the local full-voltage capacitive structure constitutes a majority of total electrical energy stored at the operating voltage in capacitances directly coupled between the cathode and the anode, the total electrical energy including electrical energy stored in one or more external full-voltage capacitances located outside the vacuum chamber. In some embodiments, the majority is at least 70 percent of the total electrical energy stored at the predetermined operating voltage in capacitances directly coupled between the conductor at the cathode potential and the conductor at the anode potential. In some embodiments, the majority is at least 90 percent.

In some embodiments, the electron beam source is configured such that no Marx generator, linear transformer driver, Tesla transformer, pulse-forming network, or pulse-forming transmission line is electrically interposed between an output of the high-voltage power supply and at least one of the cathode and the anode, such that the high-voltage power supply charges the local full-voltage capacitive structure without delivery of a shaped pulse from an external pulse-forming assembly.

In some embodiments, during a pulse, electrical energy discharged from the local full-voltage capacitive structure is transferred predominantly to electrons that traverse the vacuum gap between the cathode and the anode to form an electron beam.

In some embodiments, the local full-voltage capacitive structure further includes at least one deliberately integrated conductive feature disposed within the vacuum chamber and electrically coupled between the conductor at the cathode potential and the conductor at the anode potential to increase capacitance charged to the predetermined operating voltage.

In some embodiments, a charging element is coupled between the high-voltage power supply and at least one of the cathode and the anode, the charging element comprising at least one of a resistor, an inductor, and a current limiting element. In some embodiments, the charging element is not configured as a pulse-forming network or a pulse-forming transmission line.

In some embodiments, a recharge time constant of the local full-voltage capacitive structure is at least ten times longer than a duration of the electron pulse, the recharge time constant being determined by a product of (i) an effective charging impedance and (ii) an effective capacitance of the local full-voltage capacitive structure. In some embodiments, a peak power of the electron pulse is at least ten times greater than a maximum continuous output power rating of the high-voltage power supply.

In some embodiments, the electron beam source is configured to generate electron pulses having durations selectable over a range spanning sub-nanosecond to millisecond time scales.

In some embodiments, the anode includes at least one aperture aligned with an emission region of the cathode such that electrons emitted from the cathode pass through the aperture as an electron beam toward a target region. In some embodiments, the aperture has a tapered profile with an entrance region facing the cathode and an exit region facing downstream.

In some embodiments, the cathode has a geometry selected from the group consisting of spherical, hemispherical, flat, conical, and multifaceted geometries.

In some embodiments, the cathode comprises a plurality of emission regions supported by a common cathode body, and the anode includes a plurality of apertures aligned with respective emission regions so as to form a plurality of electron beams when emission is initiated.

In some embodiments, the triggering arrangement is selected from the group consisting of: photonic triggering of a photocathode region on the cathode; field emission triggering from a field enhanced region of the cathode; secondary emission triggering responsive to particle bombardment of the cathode; thermal triggering responsive to localized heating of the cathode; and electrical triggering using a trigger electrode positioned to influence an electric field near an emission region of the cathode.

In some embodiments, beam steering elements are disposed adjacent to an electron beam path, the beam steering elements comprising at least one of permanent magnets and microcoils configured to adjust a trajectory of an electron beam.

In some embodiments, the triggering arrangement comprises photonic triggering of a photocathode region on the cathode, and the electron beam source is configured to be arranged relative to an external event region and a target region such that a delay between an external event and arrival of the electron pulse at the target region is determined by a sum of (i) a photon travel time from the external event region to the photocathode region and (ii) an electron transit time from the photocathode region to the target region. In some embodiments, the delay is set without active timing electronics configured to phase lock or dynamically adjust timing between the external event and the electron pulse.

In some embodiments, a conductive shield is disposed between a discharge region proximate the cathode and a vacuum insulator surface within the vacuum chamber, the conductive shield being configured to reduce deposition of ablated electrode material on the vacuum insulator surface. In some embodiments, a separation feature is configured to separate a discharge region from a beam transport region within the vacuum chamber. In some embodiments, a getter element is disposed within the vacuum chamber.

In some embodiments, the predetermined operating voltage is between 50 kilovolts and 5 megavolts, and energy stored in the local full-voltage capacitive structure at the predetermined operating voltage is between 0.01 joule and 10 kilojoules.

In accordance with a first aspect of the present disclosure, an electron beam source is provided comprising: a vacuum chamber; a cathode and an anode disposed within the vacuum chamber and separated by a vacuum gap; a local full-voltage capacitive structure located within the vacuum chamber and electrically coupled between a conductor at cathode potential and a conductor at anode potential, the local full-voltage capacitive structure including a vacuum gap capacitance between the cathode and the anode across the vacuum gap; a high-voltage power supply having an output coupled to the conductor at the cathode potential and the conductor at the anode potential and configured to charge the local full-voltage capacitive structure to a predetermined operating voltage; and a triggering arrangement configured to initiate emission of electrons from the cathode to form at least one electron pulse that traverses the vacuum gap toward the anode.

In accordance with a second aspect of the present disclosure, a method is provided comprising: arranging a cathode and an anode within a vacuum chamber so that the cathode and the anode are separated by a vacuum gap and form a local full-voltage capacitive structure located within the vacuum chamber and electrically coupled between a conductor at a cathode potential and a conductor at an anode potential; charging the local full-voltage capacitive structure to a predetermined operating voltage using a high-voltage power supply coupled to the conductor at the cathode potential and the conductor at the anode potential without electrically interposing any Marx generator, linear transformer driver, Tesla transformer, pulse-forming network, or pulse-forming transmission line between an output of the high-voltage power supply and at least one of the cathode and the anode; and triggering emission of electrons from the cathode so as to discharge electrical energy stored in the local full-voltage capacitive structure predominantly into emitted electrons that traverse the vacuum gap toward the anode.

In embodiments of the method of the second aspect of the application, electrical energy stored at the predetermined operating voltage in the local full-voltage capacitive structure constitutes at least 70 percent of total electrical energy stored at the predetermined operating voltage in capacitances directly coupled between the conductor at the cathode potential and the conductor at the anode potential. A recharge time constant of the local full-voltage capacitive structure may be at least ten times longer than a duration of the electron pulse. The electron pulse may have a duration selectable over a range spanning sub-nanosecond to millisecond time scales. The method may further comprise selecting a geometry such that a delay between an external event and arrival of the electron pulse at a target region is determined by a sum of a photon travel time and an electron transit time, without active timing electronics configured to phase lock or dynamically adjust the delay. The method may additionally or alternatively comprise steering an emitted electron beam using at least one of permanent magnets and microcoils to achieve a desired beam trajectory.

Additional aspects, embodiments, and variations will be apparent from the detailed description, drawings, and claims that follow.

### BRIEF DESCRIPTION OF THE DRAWINGS

FIG. 1 is a schematic cross-sectional view of an electron beam source according to the present disclosure, showing a vacuum chamber, a cathode and an anode defining a vacuum gap and local full-voltage capacitive structure, a high-voltage power supply configured to charge the local full-voltage capacitive structure, and an electron beam directed through an anode aperture toward a target region;

FIG. 2 is an enlarged schematic view of a cathode-anode gap region showing an example cathode geometry, representative electric field lines across the vacuum gap, and an anode aperture through which an electron beam passes;

FIG. 3 is a schematic cross-sectional view of a multi-beam embodiment including a plurality of cathode emission regions supported by a common cathode body and a corresponding plurality of anode apertures, producing multiple electron beams from a shared local full-voltage capacitive structure;

FIG. 4 is a schematic illustration of beam steering elements including one or more permanent magnets and one or more microcoils arranged adjacent to an electron beam path to provide trajectory control;

FIGS. 5A-5E are schematic diagrams of example triggering arrangements configured to initiate electron emission from the cathode, including photonic triggering, field emission triggering, secondary emission triggering, thermal triggering, and electrical triggering using a trigger electrode;

FIG. 6 is a schematic diagram of an embodiment providing passive synchronization by geometry and time of flight, including a photon path from an external event region to a photocathode region and an electron path from the photocathode region to a target region;

FIG. 7 is an example timing diagram illustrating a recharge interval and a discharge interval associated with charging and discharging the local full-voltage capacitive structure;

FIG. 8 is a schematic electrical comparison showing (i) a gap dominant integrated energy storage architecture and (ii) a conventional architecture using an external pulsed-power assembly and a delivered pulse; and

FIG. 9 is a schematic cross-sectional view illustrating optional contamination management features including conductive shielding and separation of regions within the vacuum chamber.

The drawings are schematic in nature and are not necessarily to scale. Certain dimensions may be exaggerated for purposes of illustration, and similar reference numerals in different figures may denote similar or corresponding elements for convenience of description.

### DETAILED DESCRIPTION OF THE DRAWINGS

The following description sets out representative embodiments of the present disclosure. The described embodiments are examples and are not limiting. Features described in connection with one embodiment may be combined with features described in connection with other embodiments unless expressly stated otherwise. The drawings referenced herein are schematic in nature and are not necessarily to scale. Similar reference numerals may denote similar or corresponding elements.

### 1.1 System Overview and Gap Dominant Energy Storage

### 1.1.1 High-Level Architecture

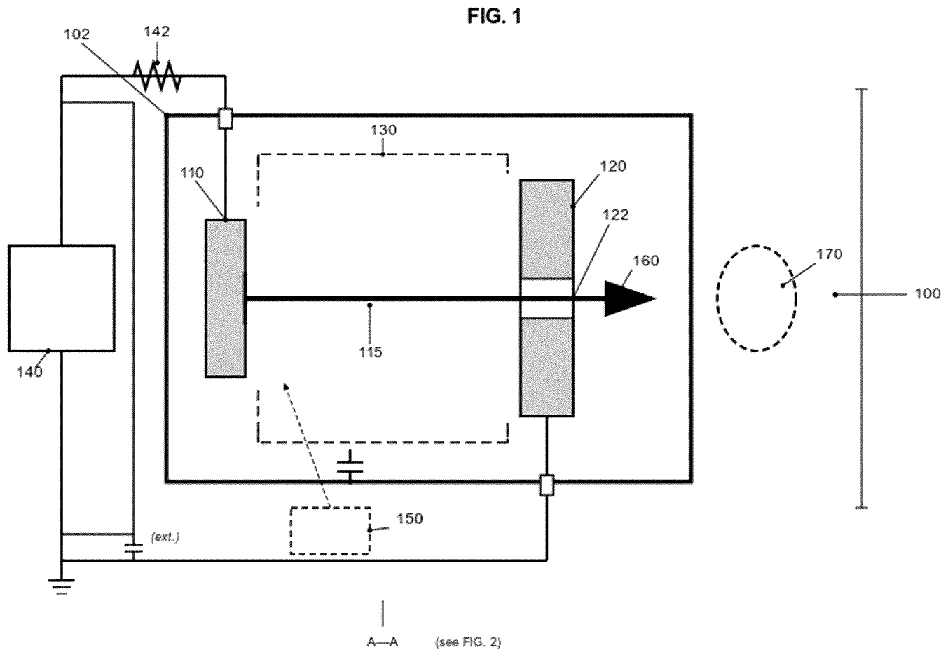

FIG. 1 illustrates an electron beam source 100. A vacuum chamber 102 encloses a cathode 110 and an anode 120 separated by a vacuum gap 115. The cathode 110 and the anode 120 are arranged to define a local full-voltage capacitive structure 130 within the vacuum chamber 102. When a voltage is applied between cathode potential and anode potential, electrical energy is stored in an electric field associated with the local full-voltage capacitive structure 130, including the electric field across the vacuum gap 115.

A high-voltage power supply 140 is coupled to the cathode 110 and the anode 120, for example through one or more vacuum feedthroughs and internal conductors. In some embodiments, the high-voltage power supply 140 charges the local full-voltage capacitive structure 130 to a predetermined operating voltage V_{OP}. In some embodiments, a charging element 142 is coupled in series between the high-voltage power supply 140 and at least one of the cathode 110 and the anode 120. A triggering arrangement 150 is configured to initiate emission of electrons from the cathode 110 to produce an electron beam 160 that traverses the vacuum gap 115 toward the anode 120. In the illustrated embodiment, the anode 120 includes an aperture 122 through which the electron beam 160 passes toward a target region 170.

In some embodiments, the electron beam source 100 is implemented such that no Marx generator, linear transformer driver, Tesla transformer, pulse-forming network, or pulse-forming transmission line is electrically interposed between an output of the high-voltage power supply 140 and at least one of the cathode 110 and the anode 120. In such embodiments, the high-voltage power supply 140 functions primarily as a charger for the local full-voltage capacitive structure 130 rather than as a source of a separately pulse-formed high-voltage waveform delivered through intermediate pulsed-power modules.

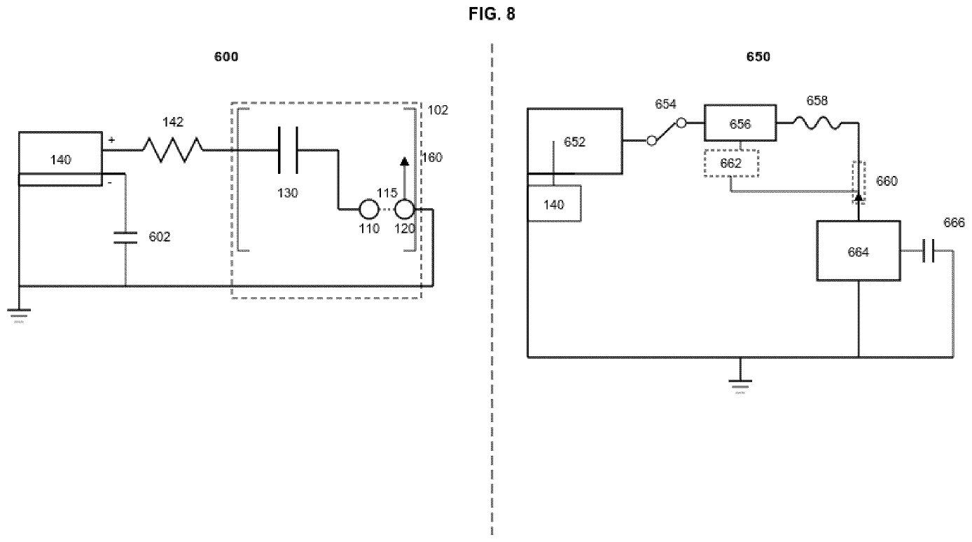

FIG. 8 illustrates a schematic electrical comparison between a gap dominant integrated energy storage architecture 600 and an external pulsed-power architecture 650. In the gap dominant architecture 600 (left), a high-voltage power supply 140 charges a local full-voltage capacitive structure 130 disposed within the vacuum chamber 102, optionally through a charging element 142. An external full-voltage capacitance 602 is shown schematically outside the vacuum chamber 102 to illustrate that external full-voltage capacitance may be present but is comparatively small relative to the local full-voltage capacitive structure 130 in representative gap-dominant implementations. During discharge, energy stored locally is released through a short path associated with the cathode 110, the anode 120, and the vacuum gap 115 to produce an electron beam 160.

In the external pulsed-power architecture 650 (right), pulse energy is stored and shaped in external pulsed-power components and delivered to an electron gun 664 through an external high-voltage path. The high-voltage power supply 140 charges an external pulse-energy storage assembly 652, and a switching element 654 initiates discharge of the assembly 652 into a pulse-forming structure 656 to generate a shaped high-voltage pulse. Parasitic inductance 658 in the discharge path is shown to represent rise-time-limiting inductance associated with switching and interconnect structures.

The shaped pulse is delivered through a high-voltage interconnect 660 to the electron gun 664. An optional impedance matching network 662 may be coupled between the pulse-forming structure 656 and the electron gun 664 and/or along the interconnect 660 to reduce reflections and tailor the delivered waveform. Stray capacitance 666 associated with the electron gun 664 and adjacent structures is shown to illustrate capacitances that are typically treated as parasitic in conventional architectures.

In some embodiments, the gap dominant architecture 600 reduces requirements for external high-current interconnects by storing pulse energy locally and releasing that energy through a short discharge path associated with the cathode 110 and anode 120, such that large pulse currents are supported primarily by local discharge while the high-voltage power supply 140 operates at a comparatively lower average power over the recharge interval.

### 1.1.2 Distinction from Prior Approaches

The gap dominant architecture described herein differs from prior pulsed electron beam systems in several respects. Conventional systems typically store pulse energy in external pulsed-power assemblies and deliver a shaped pulse through transmission lines and interconnects to an electron gun treated as a load. In contrast, the present disclosure stores the majority of pulse energy locally within the vacuum chamber 102, in capacitances dominated by the vacuum gap 115 between the cathode 110 and anode 120.

Unlike conventional feedback-based pulsed-power systems that require precise external waveform shaping, the present disclosure employs a comparatively simple high-voltage power supply 140 that charges the local full-voltage capacitive structure 130 over a recharge interval substantially longer than the pulse duration. Pulse characteristics are determined primarily by triggering and discharge dynamics rather than by externally synthesized waveforms.

### 1.2 Definitions and Interpretation

As used herein, a “local full-voltage capacitive structure” refers to an arrangement of conductors located within a vacuum chamber 102 that defines a local full-voltage capacitance electrically coupled between (i) a conductor at a cathode potential and (ii) a conductor at an anode potential. The local full-voltage capacitive structure 130 includes a vacuum gap capacitance between a cathode 110 and an anode 120 across a vacuum gap 115. The local full-voltage capacitive structure 130 may further include one or more deliberately integrated conductive features disposed within the vacuum chamber 102 and electrically coupled between the conductor at the cathode potential and the conductor at the anode potential so as to contribute to the local full-voltage capacitance.

As used herein, a “gap dominant architecture” refers to a configuration in which electrical energy stored at an operating voltage in the local full-voltage capacitive structure 130 constitutes a majority of total electrical energy stored at the operating voltage in capacitances directly coupled between the conductor at the cathode potential and the conductor at the anode potential, including any external full-voltage capacitances located outside the vacuum chamber 102. External full-voltage capacitances may include, for example, feedthrough capacitance, cabling capacitance, stray capacitance, and filter capacitance that are charged to the operating voltage between the cathode potential and the anode potential. In some embodiments, the majority is at least 70 percent. In some embodiments, the majority is at least 90 percent.

As used herein, an “electron pulse” refers to a time interval during which electron emission from the cathode 110 produces a beam current that traverses the vacuum gap 115 toward the anode 120. Electron pulse duration may be selected based on application requirements and may be influenced by triggering stimulus duration, emission physics, and discharge dynamics of the vacuum gap 115 and associated structures.

As used herein, “predominantly” (with respect to energy transfer during a pulse) means that more than 50% of electrical energy discharged from the local full-voltage capacitive structure 130 during the electron pulse is transferred to electrons that traverse the vacuum gap 115 between the cathode 110 and the anode 120. In some embodiments, more than 70% of the discharged electrical energy is transferred to electrons that traverse the vacuum gap 115. By way of example, energy transferred to electrons may be estimated by integrating beam current multiplied by an accelerating voltage over the pulse duration.

As used herein, a “pulse-forming transmission line” refers to a transmission line structure intentionally configured to store pulse energy and to discharge that energy to a load with a characteristic pulse width determined at least in part by a propagation delay of the transmission line structure (for example, a pulse-forming line). A conductor, lead, or cable is not a pulse-forming transmission line merely because it exhibits transmission line behavior.

As used herein, an “effective charging impedance” refers to a Thevenin equivalent impedance seen by the local full-voltage capacitive structure 130 during a recharge interval, including internal impedance of a high-voltage power supply 140 and any intentional series charging element 142.

### 1.3 Cathode-Anode Gap Region and Field Structure

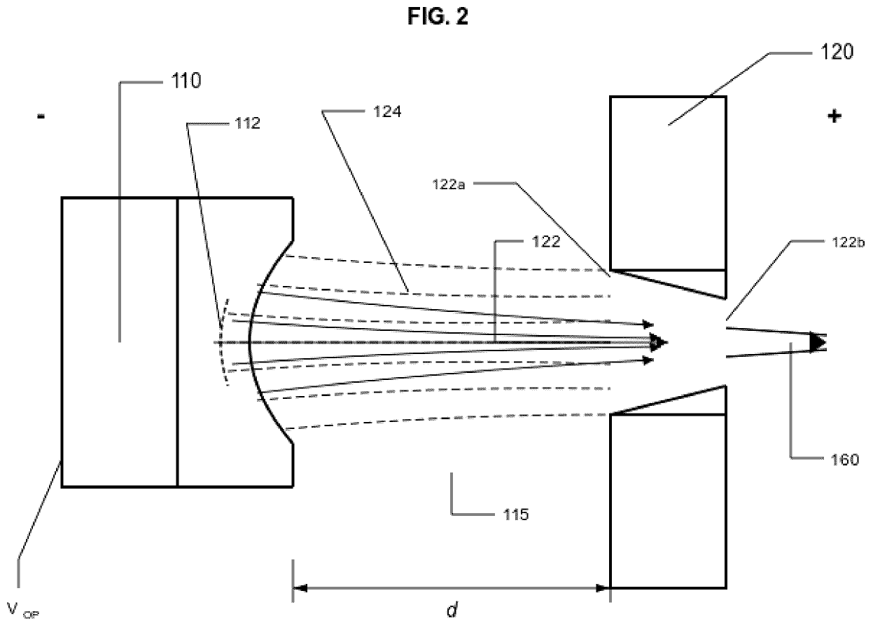

FIG. 2 illustrates an enlarged view of the cathode 110, the anode 120, and the vacuum gap 115. In the illustrated embodiment, the cathode 110 includes an emission region 112 facing the anode 120. The anode 120 includes the aperture 122 aligned with the emission region 112. Representative electric field lines 124 are shown across the vacuum gap 115 to illustrate acceleration of electrons from the cathode 110 toward the anode 120 when the operating voltage V_{OP} is applied.

In some embodiments, the cathode 110 has a geometry selected to influence an electric field distribution and electron trajectories, including spherical, hemispherical, flat, conical, and multifaceted geometries. In some embodiments, the aperture 122 has a tapered profile with an entrance region 122a facing the cathode 110 and an exit region 122b facing downstream, to guide electrons through the anode 120 and reduce clipping and backscatter.

### 1.4 Charging Elements and Recharge Behavior

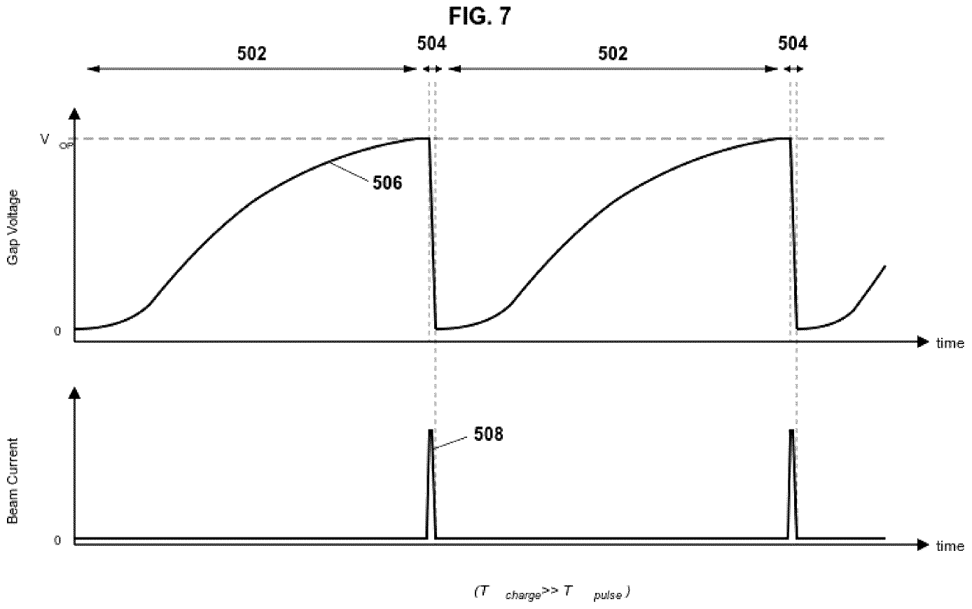

FIG. 7 illustrates an example timing diagram showing a recharge interval 502 during which the high-voltage power supply 140 charges the local full-voltage capacitive structure 130 to the operating voltage V_{OP}, and a discharge interval 504 associated with an electron pulse. Representative voltage and/or current waveforms 506, 508 are shown schematically to illustrate that stored energy accumulated during recharge may be released over a shorter discharge interval 504.

In some embodiments, the charging element 142 is coupled between the high-voltage power supply 140 and at least one of the cathode 110 and the anode 120. The charging element 142 may comprise a resistor, an inductor, a current limiting element, or a combination thereof. In some embodiments, the charging element 142 limits recharge current and reduces stress on the high-voltage power supply 140 during discharge. In some embodiments, the charging element 142 increases isolation between the high-voltage power supply 140 and fast discharge dynamics associated with the electron pulse.

In some embodiments, a recharge time constant associated with the local full-voltage capacitive structure 130 is determined by a product of (i) an effective charging impedance and (ii) an effective capacitance of the local full-voltage capacitive structure 130. In some embodiments, the recharge time constant (T_{charge}) is longer than an electron pulse duration (Tₚᵤₗₛₑ). In some embodiments, the recharge time constant is at least ten times longer than an electron pulse duration, such that pulse peak power can exceed a continuous output power rating of the high-voltage power supply 140.

### 1.5 Deliberately Integrated Local Capacitance

In some embodiments, additional capacitance is deliberately integrated within the vacuum chamber 102 and electrically coupled between cathode potential and anode potential so as to increase energy stored at V_{OP} while preserving a short, low-inductance discharge path. By way of example, such deliberately integrated capacitance may be implemented by conductive geometries positioned within the vacuum chamber 102 and electrically connected to the cathode 110 and/or the anode 120, such that the additional capacitance is charged to the operating voltage during the recharge interval 502 and participates in discharge during the electron pulse.

In some embodiments, discharge geometry is configured to reduce parasitic inductance so as to support fast current rise and short pulse formation. Non-limiting examples include coaxial arrangements, broad parallel current returns, short internal conductors, and direct mechanical integration of the cathode 110 assembly and the anode 120 assembly.

### 1.6 Pulse Formation, Emission Control, and Pulse Duration Range

In some embodiments, the triggering arrangement 150 initiates electron emission from the cathode 110 while the local full-voltage capacitive structure 130 is charged. In response to triggering, electrons emitted from the cathode 110 are accelerated across the vacuum gap 115 toward the anode 120 to form at least one electron pulse.

In various embodiments, the electron pulse duration is selectable over a wide range by controlling one or more of: triggering stimulus duration, emission mechanism, discharge impedance, and plasma formation dynamics in the vacuum gap 115. In some embodiments, an avalanche or rapid transition of the vacuum gap 115 from a high-impedance state to a conductive state produces short pulses, including nanosecond scale and sub-nanosecond pulses. In some embodiments, the duration of a photonic trigger (e.g., a light pulse applied to a photocathode region) sets or contributes to the duration of electron emission and therefore the electron pulse duration. In some embodiments, an electrical trigger electrode 158 is driven with a trigger waveform that sets or contributes to an emission duration. In some embodiments, thermionic or other sustained emission mechanisms support longer pulse durations, including microsecond class pulses and millisecond class pulses, at current levels consistent with the stored charge and discharge dynamics of the local full-voltage capacitive structure 130.

In some embodiments, during an electron pulse, electrical energy discharged from the local full-voltage capacitive structure 130 is transferred predominantly to electrons that cross the vacuum gap 115. In some embodiments, the electron pulse is delivered as a directed beam 160 through the anode aperture 122.

### 1.7 Triggering Arrangements and Avalanche Discharge

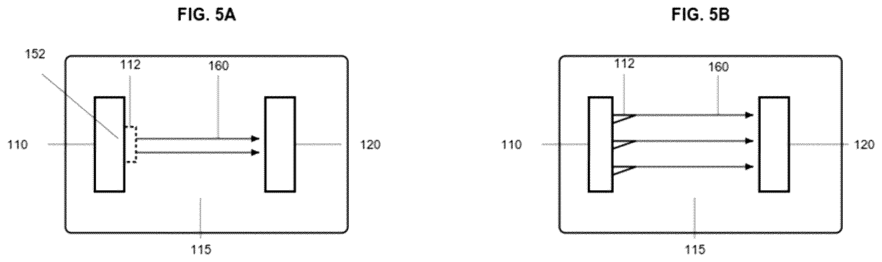

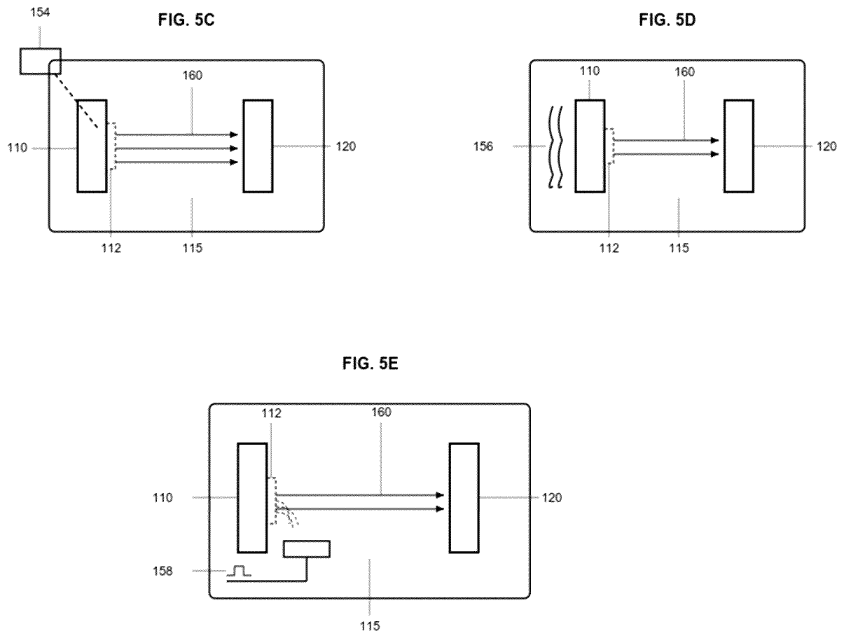

FIGS. 5A-5E illustrate example triggering arrangements 150 configured to initiate electron emission from the cathode 110 while the local full-voltage capacitive structure 130 is charged. In some embodiments, shown for example in FIG. 5A, photons 152 illuminate a photocathode region of the cathode 110 to initiate emission. In some embodiments, shown for example in FIG. 5C, a particle source 154 directs particles toward the cathode 110 to induce secondary emission. In some embodiments, shown for example in FIG. 5D, a heater or energy source 156 provides thermal triggering. In some embodiments, shown for example in FIG. 5E, a trigger electrode 158 is positioned to influence an electric field near the emission region 112 to initiate emission and/or initiate a discharge transition in the vacuum gap 115.

In some embodiments, shown for example in FIG. 5A, triggering comprises photonic triggering in which photons 152 illuminate a photocathode region on the cathode 110 to initiate electron emission. In some embodiments, shown for example in FIG. 5B, triggering comprises field emission triggering in which emission is initiated from one or more field enhanced regions of the cathode 110 when the local full-voltage capacitive structure 130 is charged to V_{OP} and/or when a supplemental trigger stimulus is applied. In some embodiments, shown for example in FIG. 5C, triggering comprises secondary emission triggering in which the particle source 154 produces particles that strike the cathode 110 and induce emission. In some embodiments, shown for example in FIG. 5D, triggering comprises thermal triggering in which localized heating of the cathode 110 initiates emission. In some embodiments, shown for example in FIG. 5E, triggering comprises electrical triggering using the trigger electrode 158 disposed within the vacuum chamber 102 and positioned to influence an electric field near the emission region 112 of the cathode 110.

In some embodiments, transition of the vacuum gap 115 from a charged high-impedance state to a discharge state involves a positive feedback avalanche process. Initial electrons emitted from the cathode 110 accelerate across the vacuum gap 115 and strike the anode 120 with energy set by V_{OP}. Localized heating, desorption, vapor formation, and ionization can increase conductivity of the gap. Ions may be accelerated toward the cathode 110 and contribute to additional electron emission and increased conduction, such that the local full-voltage capacitive structure 130 discharges a substantial portion of its stored energy during the electron pulse.

### 1.8 Multi-Beam Embodiments

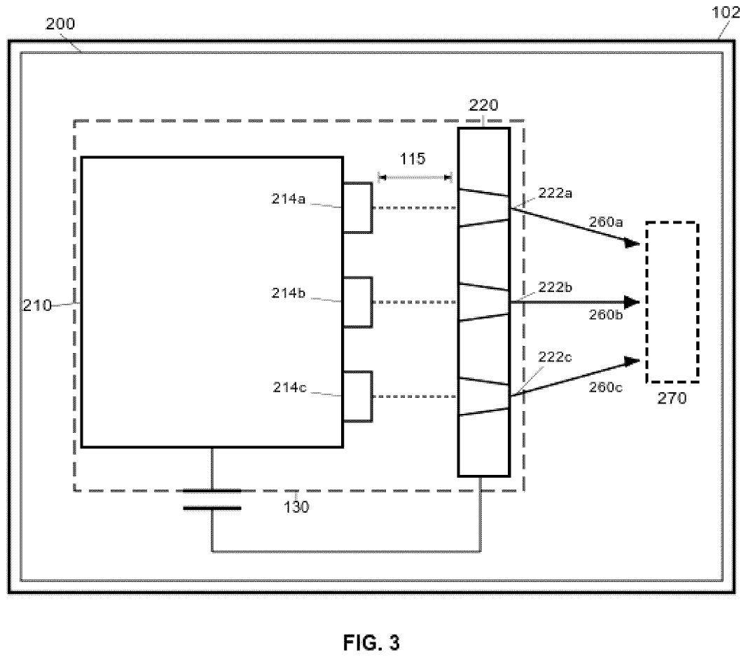

FIG. 3 illustrates a multi-beam 200 embodiment. A common cathode body 210 supports a plurality of emission regions 214a, 214b, 214c disposed to face the anode 220 across the vacuum gap 115. The anode 120 includes a plurality of apertures 222a, 222b, 222c aligned with respective emission regions 214a, 214b, 214c.

In operation, the local full-voltage capacitive structure 130 formed between the common cathode body 210 and the anode 220 stores electrical energy at V_{OP} and is discharged in connection with multiple electron beams 260a, 260b, 260c passing through respective apertures 222a, 222b, 222c. In some embodiments, multiple beams 160 are directed toward a single target region 217 to increase delivered power density. In some embodiments, multiple beams 260a, 260b, 260c are directed to multiple target regions.

### 1.9 Optional Beam Steering

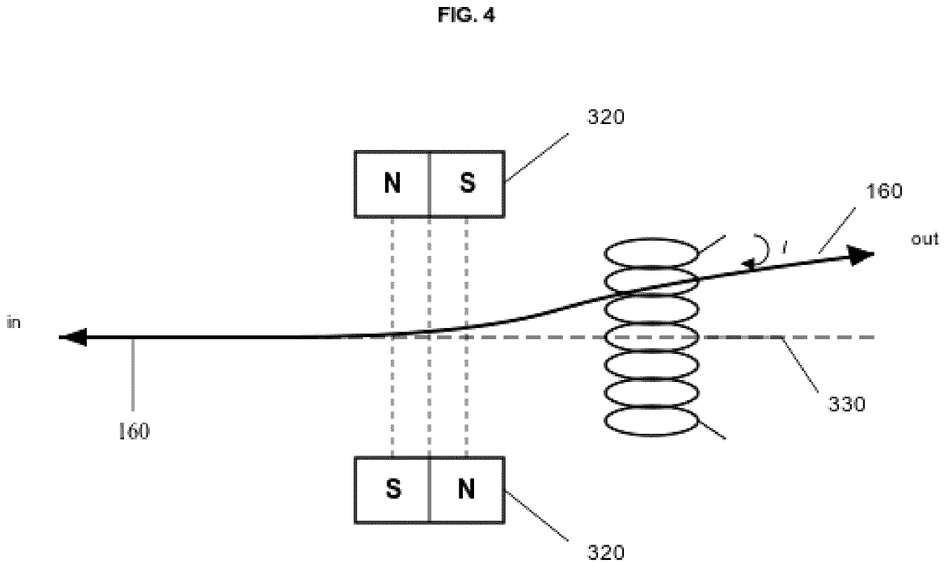

FIG. 4 illustrates beam steering elements that can be included in the electron beam sources described herein. In some embodiments, one or more permanent magnets 320 are positioned around a beam path to provide static magnetic fields for coarse deflection and/or focusing of the electron beam 160.

In some embodiments, one or more microcoils 330 are mounted adjacent to a beam path and driven by controlled currents to provide dynamic steering, trimming, or fine adjustment of a beam trajectory. In some embodiments, the microcoils 330 are driven by separate low-voltage electronics and are not part of a primary discharge current path of the local full-voltage capacitive structure 130.

### 1.10 Passive Synchronization by Geometry and Time of Flight

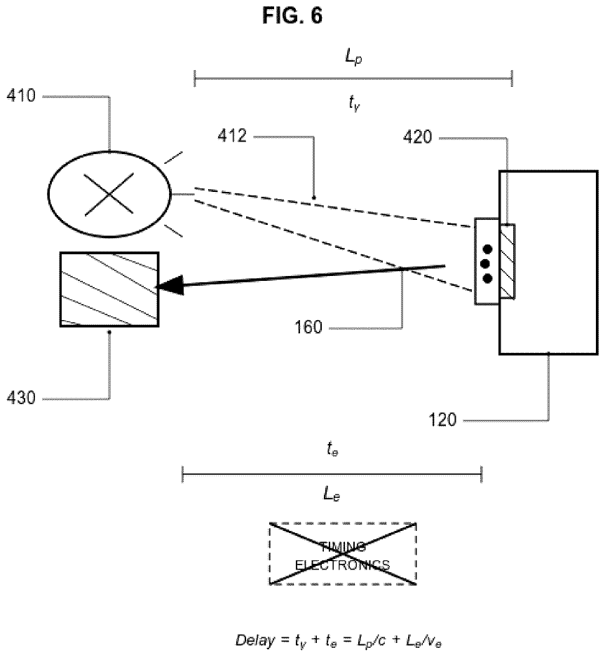

FIG. 6 illustrates an embodiment in which an electron pulse is passively synchronized to an external event through geometry and time of flight. An external event region 410 emits photons 412 that travel along a photon path to a photocathode region 420 on or associated with the cathode 110. Electrons emitted from the photocathode region 420 traverse the vacuum gap 115 and propagate along an electron path 160 toward the target region 430. In the illustrated embodiment, a delay between the external event and arrival of an electron pulse at the target region 430 is established by geometry and time of flight (t) rather than by active timing electronics.

In some embodiments, distances along the photon path (Lₚ) and the electron path (Lₑ), together with the operating voltage V_{OP}, are selected such that a delay between the external event and arrival of the electron pulse at the target region 430 is determined by a sum of a photon travel time (t_{y}) and an electron transit time (tₑ).

No active timing electronics (including phase locked loops, RF phase locking, or variable delay control) are required to set the delay in the embodiment of FIG. 6. The delay is established by geometry and time of flight.

### 1.11 Optional Contamination Management and Lifetime Features

In some embodiments, discharge of the vacuum gap 115 can produce ablated electrode material 760 and/or desorbed species that may deposit within the vacuum chamber 102, including on vacuum insulator surfaces.

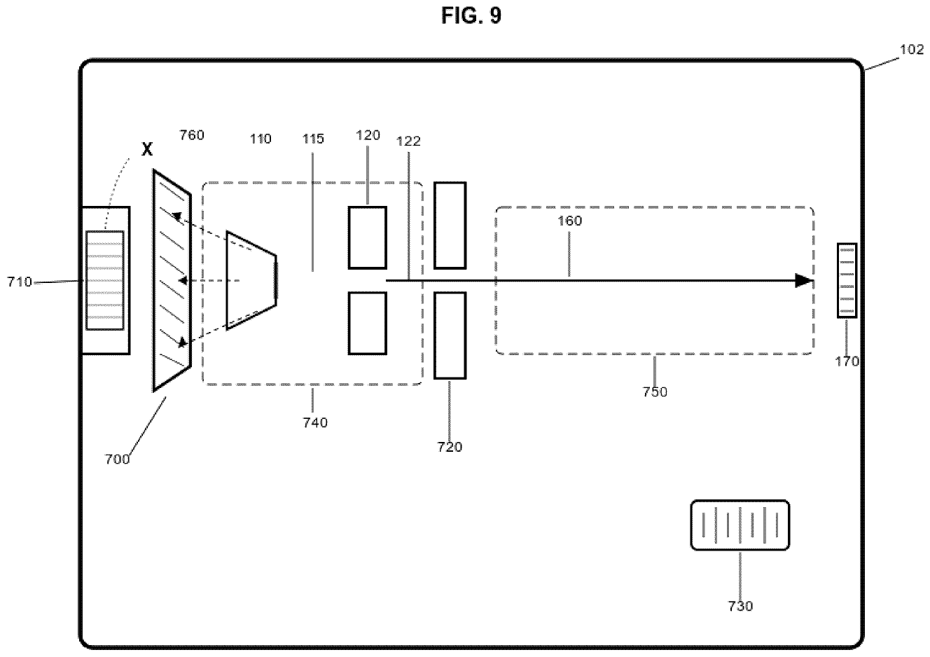

FIG. 9 illustrates optional contamination management features. In some embodiments, a conductive shield 700 is disposed to reduce deposition on a vacuum insulator surface 710, for example by blocking line of sight from the emission region 112 to the vacuum insulator surface 710. In some embodiments, a separation feature 720 is configured to separate a discharge region 740 from a beam transport region 750, for example by restricting line of sight transport of particles and/or by providing a conductance limiting passage between regions. In some embodiments, a getter element 730 is disposed within the vacuum chamber 102 to assist in maintaining vacuum conditions.

### 1.12 Example Parameter Ranges and Estimation

In various embodiments, the operating voltage V_{OP} is between 50 kilovolts and 5 megavolts. In various embodiments, energy stored in the local full-voltage capacitive structure 130 at V_{OP} is between 0.01 joule and 10 kilojoules.

In some embodiments, stored energy is estimated using: U=(½)C V_{OP}², where C is an effective capacitance of the local full-voltage capacitive structure 130.

In some embodiments, a characteristic discharge time is estimated using: τ=√(L C), where L is an effective discharge path inductance and C is the effective capacitance of the local full-voltage capacitive structure 130.

The foregoing ranges and estimates are provided to illustrate implementation and are not limiting.

Numerous modifications and alternative embodiments will be apparent to those of ordinary skill in the art in view of this disclosure. Unless otherwise expressly limited by the claims, the scope of the present disclosure encompasses such variations.

What is claimed is:

1. An electron beam source comprising:
a vacuum chamber;
a cathode and an anode disposed within the vacuum chamber and separated by a vacuum gap;
a local full-voltage capacitive structure located within the vacuum chamber and electrically coupled between (i) a conductor at a cathode potential and (ii) a conductor at an anode potential, the local full-voltage capacitive structure including a vacuum gap capacitance between the cathode and the anode across the vacuum gap;
a high-voltage power supply having an output coupled to the conductor at the cathode potential and the conductor at the anode potential and configured to charge the local full-voltage capacitive structure to a predetermined operating voltage; and
a triggering arrangement configured to initiate emission of electrons from the cathode to form at least one electron pulse that traverses the vacuum gap toward the anode;
wherein electrical energy stored at the predetermined operating voltage in the local full-voltage capacitive structure constitutes a majority of total electrical energy stored at the predetermined operating voltage in capacitances directly coupled between the conductor at the cathode potential and the conductor at the anode potential, the total electrical energy including electrical energy stored in one or more external full-voltage capacitances located outside the vacuum chamber;
wherein the electron beam source does not include any Marx generator, linear transformer driver, Tesla transformer, pulse-forming network, or pulse-forming transmission line electrically interposed between the output of the high-voltage power supply and at least one of the cathode and the anode; and
wherein, during the electron pulse, electrical energy discharged from the local full-voltage capacitive structure is transferred predominantly to electrons that cross the vacuum gap between the cathode and the anode.

2. The electron beam source of claim 1, wherein the majority is at least 70 percent of the total electrical energy stored at the predetermined operating voltage in capacitances directly coupled between the conductor at the cathode potential and the conductor at the anode potential.

3. The electron beam source of claim 1, wherein the majority is at least 90 percent of the total electrical energy stored at the predetermined operating voltage in capacitances directly coupled between the conductor at the cathode potential and the conductor at the anode potential.

4. The electron beam source of claim 1, wherein the local full-voltage capacitive structure further includes at least one deliberately integrated conductive feature disposed within the vacuum chamber and electrically coupled between the conductor at the cathode potential and the conductor at the anode potential to increase capacitance charged to the predetermined operating voltage.

5. The electron beam source of claim 1, further comprising a charging element coupled between the high-voltage power supply and at least one of the cathode and the anode, the charging element comprising at least one of a resistor, an inductor, and a current limiting element.

6. The electron beam source of claim 5, wherein the charging element is not configured as a pulse-forming network or a pulse-forming transmission line.

7. The electron beam source of claim 1, wherein a recharge time constant of the local full-voltage capacitive structure is at least ten times longer than a duration of the electron pulse, the recharge time constant being determined by a product of (i) an effective charging impedance and (ii) an effective capacitance of the local full-voltage capacitive structure.

8. The electron beam source of claim 1, wherein a peak power of the electron pulse is at least ten times greater than a maximum continuous output power rating of the high-voltage power supply.

9. The electron beam source of claim 1, wherein the electron beam source is configured to generate electron pulses having durations selectable over a range spanning sub-nanosecond to millisecond time scales.

10. The electron beam source of claim 1, wherein the anode includes at least one aperture aligned with an emission region of the cathode such that emitted electrons pass through the aperture as an electron beam toward a target region.

11. The electron beam source of claim 10, wherein the aperture has a tapered profile with an entrance region facing the cathode and an exit region facing downstream.

12. The electron beam source of claim 1, wherein the cathode has a geometry selected from the group consisting of spherical, hemispherical, flat, conical, and multifaceted geometries.

13. The electron beam source of claim 1, wherein the cathode comprises a plurality of emission regions supported by a common cathode body, and wherein the anode includes a plurality of apertures aligned with respective emission regions so as to form a plurality of electron beams when emission is initiated.

14. The electron beam source of claim 1, wherein the triggering arrangement is selected from the group consisting of: photonic triggering of a photocathode region on the cathode; field emission triggering from a field enhanced region of the cathode; secondary emission triggering responsive to particle bombardment of the cathode; thermal triggering responsive to localized heating of the cathode; and electrical triggering using a trigger electrode positioned to influence an electric field near an emission region of the cathode.

15. The electron beam source of claim 1, further comprising beam steering elements disposed adjacent to an electron beam path, the beam steering elements comprising at least one of permanent magnets and microcoils configured to adjust a trajectory of an electron beam.

16. The electron beam source of claim 1, wherein the triggering arrangement comprises photonic triggering of a photocathode region on the cathode, and wherein the electron beam source is configured to be arranged relative to an external event region and a target region such that a delay between an external event and arrival of the electron pulse at the target region is determined by a sum of (i) a photon travel time from the external event region to the photocathode region and (ii) an electron transit time from the photocathode region to the target region.

17. The electron beam source of claim 16, wherein the delay is set without active timing electronics configured to phase lock or dynamically adjust timing between the external event and the electron pulse.

18. The electron beam source of claim 1, further comprising a conductive shield disposed between a discharge region proximate the cathode and a vacuum insulator surface within the vacuum chamber, the conductive shield being configured to reduce deposition of ablated electrode material on the vacuum insulator surface.

19. The electron beam source of claim 1, further comprising a separation feature configured to separate a discharge region from a beam transport region within the vacuum chamber.

20. The electron beam source of claim 1, further comprising a getter element disposed within the vacuum chamber.

21. The electron beam source of claim 1, wherein the predetermined operating voltage is between 50 kilovolts and 5 megavolts, and wherein energy stored in the local full-voltage capacitive structure at the predetermined operating voltage is between 0.01 joule and 10 kilojoules.

22. A method of generating an electron pulse, the method comprising:
arranging a cathode and an anode within a vacuum chamber so that the cathode and the anode are separated by a vacuum gap and form a local full-voltage capacitive structure located within the vacuum chamber and electrically coupled between a conductor at a cathode potential and a conductor at an anode potential;
charging the local full-voltage capacitive structure to a predetermined operating voltage using a high-voltage power supply coupled to the conductor at the cathode potential and the conductor at the anode potential without electrically interposing any Marx generator, linear transformer driver, Tesla transformer, pulse-forming network, or pulse-forming transmission line between an output of the high-voltage power supply and at least one of the cathode and the anode; and
triggering emission of electrons from the cathode so as to discharge electrical energy stored in the local full-voltage capacitive structure predominantly into emitted electrons that traverse the vacuum gap toward the anode.

23. The method of claim 22, wherein electrical energy stored at the predetermined operating voltage in the local full-voltage capacitive structure constitutes at least 70 percent of total electrical energy stored at the predetermined operating voltage in capacitances directly coupled between the conductor at the cathode potential and the conductor at the anode potential.

24. The method of claim 22, wherein a recharge time constant of the local full-voltage capacitive structure is at least ten times longer than a duration of the electron pulse.

25. The method of claim 22, wherein the electron pulse has a duration selectable over a range spanning sub-nanosecond to millisecond time scales.

26. The method of claim 22, further comprising selecting a geometry such that a delay between an external event and arrival of the electron pulse at a target region is determined by a sum of a photon travel time and an electron transit time, without active timing electronics configured to phase lock or dynamically adjust the delay.

27. The method of claim 22, further comprising steering an emitted electron beam using at least one of permanent magnets and microcoils to achieve a desired beam trajectory.
